(19) United States
(12) Patent Application Publication
(10) Pub. No.: US 2015/0087295 A1
(43) Pub. Date: Mar. 26, 2015

(54) SERVING CELL AND NEIGHBOR CELL PATH LOSS RELATIVE LEVEL REPORTING

(71) Applicant: QUALCOMM Incorporated, San Diego, CA (US)

(72) Inventors: Ming YANG, San Diego, CA (US); Tom CHIN, San Diego, CA (US)

(73) Assignee: QUALCOMM Incorporated, San Diego, CA (US)

(21) Appl. No.: 14/278,691

(22) Filed: May 15, 2014

Related U.S. Application Data
(60) Provisional application No. 61/883,114, filed on Sep. 26, 2013.

(51) Int. Cl. H04W 24/08; H04W 72/14

(52) U.S. Cl. CPC H04W 24/08; H04W 72/14
USPC 455/422.1

(57) ABSTRACT

A method of wireless communication includes receiving, from an user equipment (UE), a report of relative neighbor cell path loss levels and corresponding neighbor cell indexes for intra-frequency neighbor cells. The method also includes receiving, from a radio network controller (RNC), uplink loading conditions for the intra-frequency neighbor cells. The method further includes allocating a power grant based on the relative neighbor cell path loss levels and the uplink loading conditions.

### CROSS-REFERENCE TO RELATED APPLICATION

The present application claims the benefit of U.S. Provisional Patent Application No. 61/883,114, filed on Sep. 26, 2013, in the names of M. Yang et al., the disclosure of which is expressly incorporated by reference herein in its entirety.

### TECHNICAL FIELD

Aspects of the present disclosure relate generally to wireless communication systems, and more particularly, to serving cell and neighbor cell path loss relative level reporting.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA), which extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the present disclosure, a method of wireless communication is disclosed. The method includes reporting, for base station power grant allocation, relative neighbor cell path loss levels and corresponding neighbor cell indexes for a set of intra-frequency neighbor cells.

Another aspect discloses a method of wireless communication. The method includes receiving, from a user equipment (UE), a report of relative neighbor cell path loss levels and corresponding neighbor cell indexes for a set of intra-frequency neighbor cells. The method also includes receiving, from a radio network controller (RNC), uplink loading conditions for the set of intra-frequency neighbor cells. The method further includes allocating a power grant based on the relative neighbor cell path loss levels and the uplink loading conditions.

Yet another aspect discloses a wireless communication apparatus having a memory and at least one processor. The processor(s) is configured to receive a report of relative neighbor cell path loss levels and corresponding neighbor cell indexes for a set of intra-frequency neighbor cells. The processor(s) is also configured to receive uplink loading conditions for the set of intra-frequency neighbor cells. The processor(s) is further configured to allocate a power grant based on the relative neighbor cell path loss levels and the uplink loading conditions.

Another aspect discloses a wireless communication apparatus having a memory and at least one processor coupled to the memory. The processor(s) is configured to report, for base station power grant allocation, relative neighbor cell path loss levels and corresponding neighbor cell indexes for a set of intra-frequency neighbor cells.

### BRIEF DESCRIPTION OF THE DRAWINGS

For a more complete understanding of the present disclosure, reference is now made to the following description taken in conjunction with the accompanying drawings.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates neighbor and serving cell coverage areas according to aspects of the present disclosure.

FIG. 5 is a flow diagram illustrating a wireless communication method for transmitting relative serving neighbor path loss levels according to aspects of the present disclosure.

FIG. 6 is a flow diagram illustrating a wireless communication method for receiving relative serving neighbor path loss levels according to aspects of the present disclosure.

FIG. 7 is a block diagram illustrating an example of a hardware implementation for an apparatus employing a processing system.

FIG. 8 is a block diagram illustrating another example of a hardware implementation for an apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

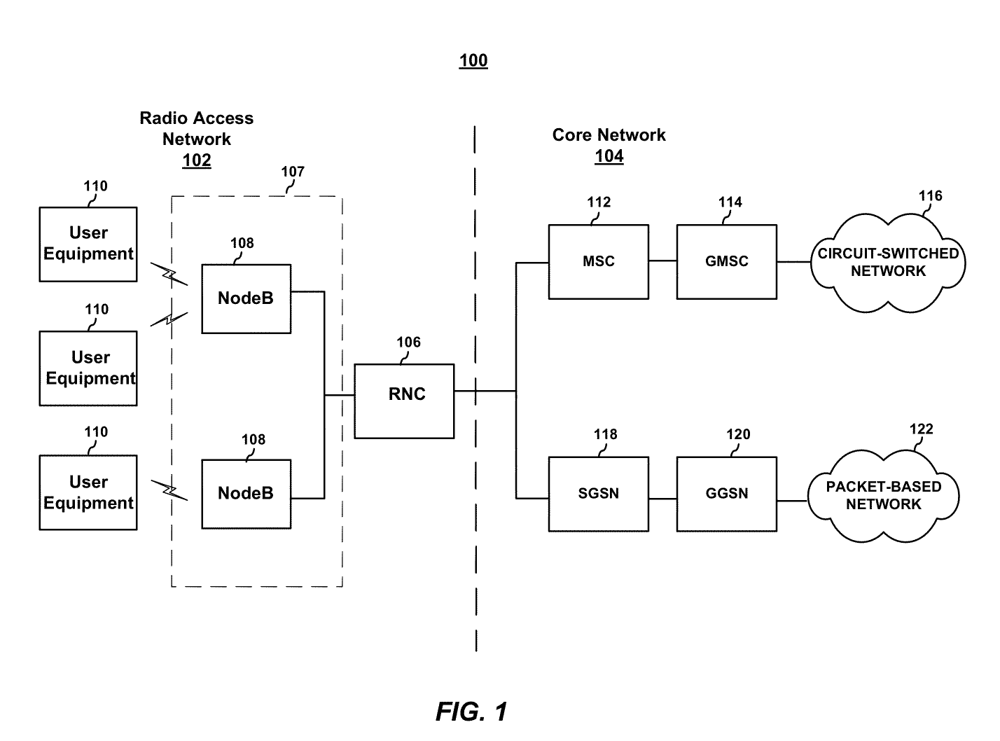

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving general packet radio service (GPRS) support node (SGSN) 118 and a gateway GPRS support node (GGSN) 120. General packet radio service (GPRS) services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

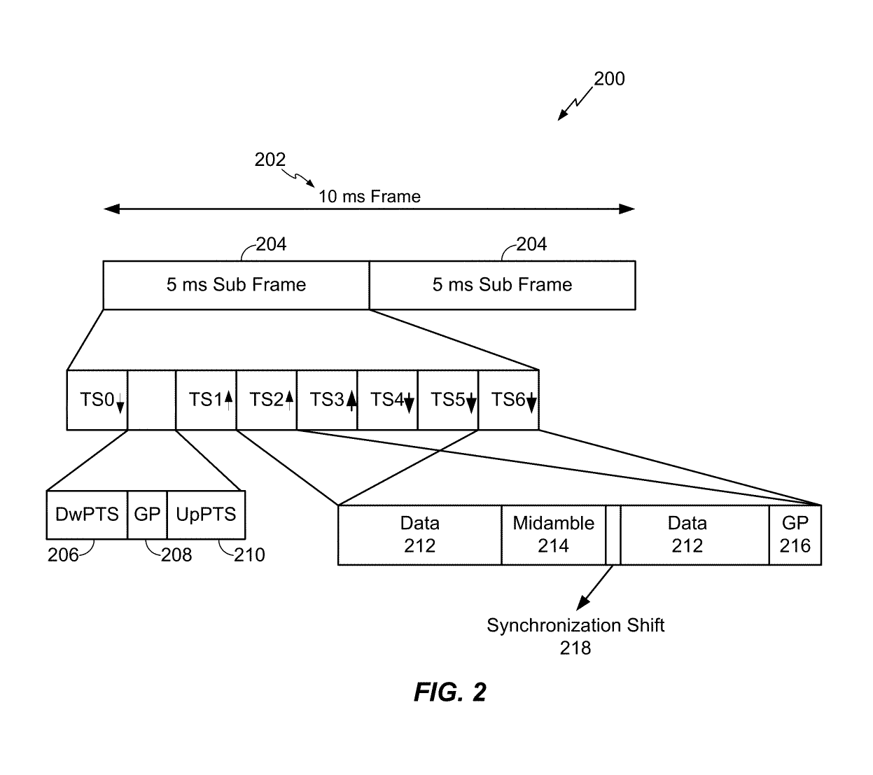

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. Synchronization shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

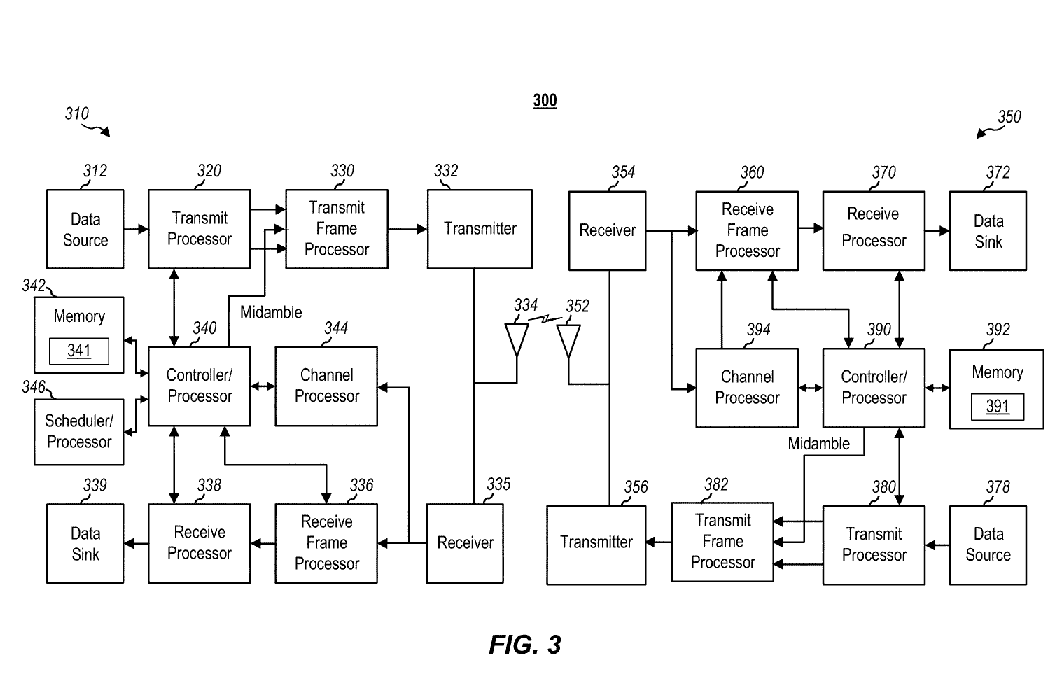

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store a relative serving neighbor path loss reporting module 391 which, when executed by the controller/processor 390, configures the UE 350 to report a relative serving neighbor path loss (SNPL). Also, the memory 342 of the node B 310 may store a relative serving neighbor path loss receiving module 341 which, when executed by the controller/processor 340, configures the node B 310 to receive a relative SNPL. A scheduler/processor 346 at the node B 310 may be used to allocate resources to the UEs and schedule downlink and/or uplink transmissions for the UEs.

TD-HSUPA is an enhancement to TD-SCDMA to improve uplink throughput. In TD-HSUPA, the enhanced uplink dedicated channel (E-DCH) is a dedicated transport channel that features enhancements to an existing dedicated transport channel carrying data traffic.

The enhanced data channel (E-DCH) or enhanced physical uplink channel (E-PUCH) carries E-DCH traffic and schedule information (SI). Information in this E-PUCH channel can be transmitted in a burst fashion.

The E-DCH uplink control channel (E-UCCH) carries layer 1 (or physical layer) information for E-DCH transmissions. The transport block size may be 6 bits and the retransmission sequence number (RSN) may be 2 bits. Also, the hybrid automatic repeat request (HARQ) process ID may be 2 bits.

The E-DCH random access uplink control channel (E-RUCCH) is an uplink physical control channel that carries SI and enhanced radio network temporary identities (E-RNTI) for identifying UEs.

The absolute grant channel for E-DCH (E-AGCH or enhanced access grant channel) carries grants for E-PUCH transmission, such as the maximum allowable E-PUCH transmission power, time slots, and code channels.

The hybrid automatic repeat request (hybrid ARQ or HARQ) indication channel for E-DCH (E-HICH) carries HARQ ACK/NACK signals.

The operation of TD-HSUPA may also have the following steps. First, in the resource request step, the UE sends requests (e.g., via Scheduling Information (SI)) via the E-PUCH or the E-RUCCH to a base station (e.g., NodeB). The requests are for permission to transmit on the uplink channels. Second, in the resource allocation step, the base station, which controls the uplink radio resources, allocates resources. Resources are allocated in terms of scheduling grants (SGs) to individual UEs based on their requests. Third, in the UE transmission step, the UE transmits on the uplink channels after receiving grants from the base station. The UE determines the transmission rate and the corresponding transport format combination (TFC) based on the received grants. The UE may also request additional grants if it has more data to transmit. Fourth, in the base station reception step, a hybrid automatic repeat request (Hybrid ARQ or HARQ) process is employed for the rapid retransmission of erroneously received data packets between the UE and the base station.

The transmission of scheduling information (SI) may consist of two types in TD-HSUPA: (1) In-band and (2) Out-band. For In-band, which may be included in medium access control e-type protocol data unit (MAC-e PDU) on the E-PUCH, data can be sent standalone or may piggyback on a data packet. For Out-band, data may be sent on the E-RUCCH in case that the UE does not have a grant. Otherwise, the grant expires.

Scheduling Information (SI) includes the following information or fields: the highest priority logical channel ID (HLID) field, the total E-DCH buffer status (TEBS) field, the highest priority logical channel buffer status (HLBS) field and the UE power headroom (UPH) field.

The highest priority logical channel ID (HLID) field unambiguously identifies the highest priority logical channel with available data. If multiple logical channels exist with the highest priority, the one corresponding to the highest buffer occupancy will be reported.

The total E-DCH buffer status (TEBS) field identifies the total amount of data available across all logical channels for which reporting has been requested by the radio resource control (RRC) and indicates the amount of data in number of bytes that is available for transmission and retransmission in the radio link control (RLC) layer. When the medium access control (MAC) is connected to an acknowledged mode (AM) RLC entity, control protocol data units (PDUs) to be transmitted and RLC PDUs outside the RLC transmission window shall also be included in the TEBS. RLC PDUs that have been transmitted but not negatively acknowledged by the peer entity shall not be included in the TEBS. The actual value of TEBS transmitted is one of 31 values that are mapped to a range of number of bytes (e.g., 5 mapping to TEBS, where 24<TEBS<32).

The highest priority logical channel buffer status (HLBS) field indicates the amount of data available from the logical channel identified by HLID, relative to the highest value of the buffer size reported by TEBS. In one configuration, this report is made when the reported TEBS index is not 31, and relative to 50,000 bytes when the reported TEBS index is 31. The values taken by HLBS are one of a set of 16 values that map to a range of percentage values (e.g., 2 maps to 6%<HLBS<8%).

The UE power headroom (UPH) field indicates the ratio of the maximum UE transmission power and the corresponding dedicated physical control channel (DPCCH) code power.

The serving neighbor path loss (SNPL) reports the path loss ratio between the serving cell and the neighboring cells. The base station scheduler incorporates the SNPL for inter-cell interference management tasks to avoid neighbor cell overload.

Some HSUPA systems may support soft handover. For example, a wideband-code division multiple access (W-CDMA) system supports soft handover. Other HSUPA systems, however, do not support soft handover. For example, time division high speed uplink packet access (TD-HSUPA) systems do not support soft handover.

Soft handover and other implementations may be used to mitigate interference introduced during high speed uplink transmission. For example, every time the UE performs any high speed uplink transmission, the UE introduces interference to neighbor cells located close to the UE. If the neighbor cells become overloaded with interference, a power grant may be sent to the UE that requests the UE to reduce its transmission power. A high transmission power causes interference from the UE to its nearby neighbor cells. However, transmission power may not cause interference to neighbor cells located far away from the UE.

During soft handover, the UE can receive relative power grants from multiple cells because the UE communicates with multiple cells. The relative power grants can manage uplink inter-cell interference when the cells in a set are in an overload condition. The overloaded cells can send down commands to request the UE to reduce the HSUPA transmission power. When the cells in the set are not in an overload condition, the cells can send up commands to request the UE to increase the HSUPA transmission power for high throughput. In either case, the power grants can be sent in an enhanced relative grant channel (E-RGCH).

A power grant may adjust the UE transmission power. This helps a base station, which may only receive transmitted signals that are at or above a fixed power level. A base station may determine a power grant based on a timing advance command, which corresponds to how far the UE is from the base station. A power grant may also be determined if relevant data (such as power headroom) is included in a schedule request. However, there may be no power headroom data present in the schedule request. The location of neighbor cells can also be used to determine a power grant. In one configuration, the power grant is sent to the UE over the enhanced physical uplink channel (E-PUCH).

### Serving Cell and Neighbor Cell Path Loss Relative Level Reporting

Aspects of the disclosure are directed to serving cell and neighbor cell path loss relative level reporting. Aspects of the disclosure may be implemented in a high speed uplink packet access (HSUPA) system, such as time division-high speed uplink packet access (TD-HSUPA). Other radio access technologies are also contemplated. For ease of illustration, however, the explanation will be presented with respect to TD-HSUPA. A base station scheduler receives reports of a serving neighbor path loss (SNPL). The SNPL indicates the path loss ratio between the serving cell and the neighboring cells in a particular radio access technology (RAT).

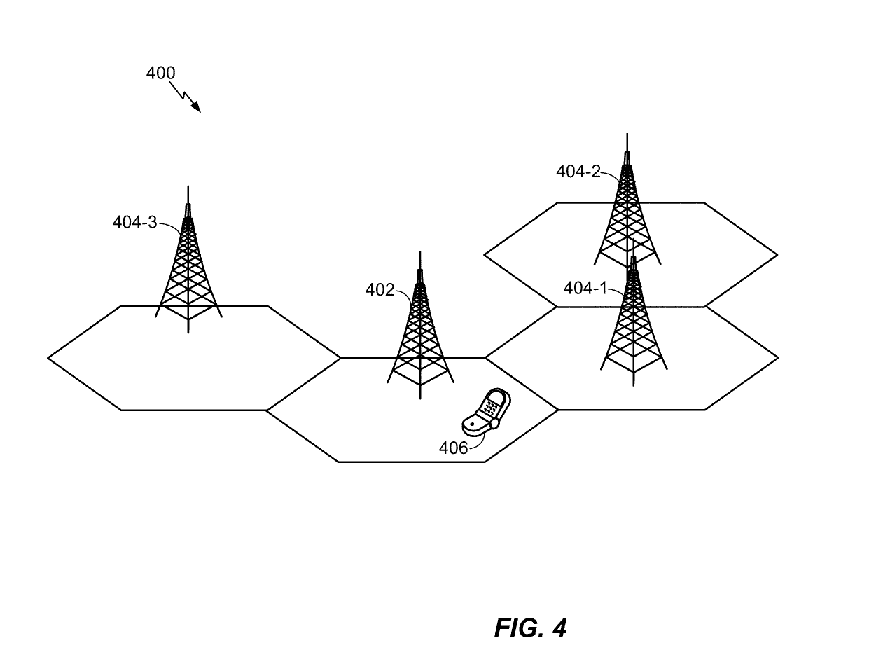

Path loss is defined to be the reduction of power density or the attenuation of a signal as it propagates through space or any communications medium. Thus, path loss corresponds to distance: the higher the path loss, the greater the distance between the transmitter and receiver. Usually, the SNPL is a single value that is the sum of the path loss values for all the neighbor cells divided by the path loss value for the serving cell. For example, referring to FIG. 4, the UE 406 in the TD-HSUPA system 400 reports an SNPL that is the ratio of the path loss between each neighbor cell 404-1, 404-2, 404-3 (collectively 404) and the UE 406, divided by the path loss between the serving cell 402 and the UE 406.

The base station scheduler uses the SNPL for E-PUCH power resource allocation. For example, the base station 402 may use SNPL information received from a UE to control the interference to neighbor cells 404, and to avoid neighbor cell overload due to high levels of interference.

Although some HSUPA systems (e.g., TD-HSUPA) may not support soft handover, interference to neighbor cells can be determined by other methods. For example, interference to the neighbor cells may be determined based on a location of the UE. The UE location dictates the path loss between the UE and the serving cell as well as between the UE and the neighbor cells. The reported SNPL is used by the base station scheduler for inter-cell interference management to avoid neighbor cell uplink overloading. Because the UE does not know the uplink load conditions of neighbor cells, however, the SNPL report does not take into account the load conditions of neighbor cells. Therefore, when the base station scheduler receives a single SNPL value, it cannot make a proper power grant, which is usually sent over the E-PUCH. A proper power grant achieves high throughput and avoids neighbor cell overload.

In a typical SNPL reporting process, the UE measures all path loss values for all the neighbor cells and sums them together, and then divides this sum by the path loss value of the serving cell to reach a single SNPL value. Usually this single SNPL value is expressed as a ratio or a fraction of the sum of the neighbor cell path loss values over the serving cell path loss value. Therefore, when this single SNPL value is reported by the UE, a base station does not know which neighbor cells are close to the UE, and which neighbor cells are far away from the UE. As a result, the base station blindly determines a power grant to reduce or increase a UE transmission power without knowing a relative proximity of the neighbor cells (i.e., how far or how close the neighbor cells are to the UE) and thus how much impact the increase/decrease will have on each individual neighboring base stations.

Further, radio network controller (RNC) measurement reports do not indicate the relative proximity of the neighbor cells. The RNC can measure or otherwise obtain the uplink loading conditions or uplink interference from the neighbor cells and/or serving cells. The RNC forwards this information to all the other cells. In some implementations, each neighbor cell or serving cell measures their own uplink loading conditions and reports that information to the RNC to be forwarded to the other cells. However, the RNC cannot inform the base stations of the location of neighbor cells relative to particular UEs.

According to an aspect of the present disclosure, the UE reports path loss information for each of the cells to the base station and the relative location of each of these cells with respect to the UE. For example, the UE may indicate which neighbor cell is closest and which neighbor cell is furthest from the UE. Reporting the relative location of each of the cells with respect to the UE improves the allocation of power grants by a base station. The path loss information for each cell may be reported in conjunction with identifying information, such as a neighbor cell index or cell ID. This path loss information and the relative location of the cells may be reported in a scheduling request.

For example, a neighbor cell index or cell ID for the neighbor cell 404-1, and path loss information (i.e., relative location) of the neighbor cell 404-1 are reported to the base station 402 by the UE 406. To allocate a power grant, the base station scheduler checks uplink loading conditions for all the neighbor cells 404, including the selected neighbor cell 404-1, from the report received from the RNC. If the UE 406 is close to the selected neighbor cell 404-1 but the uplink loading conditions on that cell are light, then the UE 406 may transmit at a higher power. This is a more intelligent and informed method of adjusting the transmission power of the UE 406 because it takes into account the location of the neighbor cells 404. That is, unlike the typical approach, the above approach does not blindly reduce or increase the UE transmission power without knowing the location of the neighbor cells.

According to another aspect of the present disclosure, the UE sends, for base station power grant allocation, a schedule request containing the top N neighbor cells 404 closest to the UE 406 (e.g., the top 3, the top 5, the top 6 closest neighbor cells). The top N neighbor cells 404 closest to the UE 406 are selected because they have the lowest relative serving neighbor path loss (SNPL) levels, or relative neighbor cell path loss levels. The SNPL is relative because it is with respect to each other neighbor cell 404. In one configuration, the relative SNPL level for each top N neighbor cell 404 represents the neighbor cell path loss of that specific top N neighbor cell 404 divided by the serving cell path loss.

Two things are therefore reported by the UE 406 to the base station 402: (1) the relative SNPL level, or relative neighbor cell path loss level for each neighbor cell and (2) a neighbor cell index, or cell ID. In one configuration, the above-described information may be within a scheduling request.

In one configuration, three (3) bits represent the relative SNPL level or relative neighbor cell path loss level for a neighbor cell. In this example, “000” represents the lowest path loss and “111” represents the highest path loss. The neighbor cell index may be represented with 5 bits. For example, the neighbor cell index can range from 0, 1, 2, 3 . . . 31. The neighbor cell index is indicated by the network, such as a radio resource control (RRC) measurement control message from the network.

The relative SNPL and neighbor cell index information may be conveyed when the UE sends a medium access control e-type protocol data unit (MAC-ePDU) carried in the E-PUCH. For example, the information can be sent in the padding bits. If eight bits of information are included, the MAC-ePDU can be used when there are eight or more padding bits.

In one configuration, the neighbor cells include neighbor cells having an absolute path loss below a first threshold and/or a relative path loss below a second threshold. Whichever neighbor cells that have an absolute path loss below the first threshold and/or relative path loss below the second threshold are reported in the neighbor cell index. In one configuration, the relative neighbor cell path loss level includes a ratio of neighbor cell path loss to serving cell path loss. Thus, the reported neighbor cells include neighbor cells with lower path loss levels.

In one configuration, the neighbor cells are intra-frequency neighbor cells. In other words, the neighbor cells operate at the same frequency.

Therefore, provided is a method to control uplink interference to other neighbor cells by having the UE report, for base station power grant allocation, relative neighbor cell path loss levels and corresponding neighbor cell IDs for a set of intra-frequency neighbor cells. For example, the UE reports, in a schedule request, to the base station one or more relative SNPL levels (or relative neighbor cell path loss levels) of a set of intra-frequency neighbor cells along with their corresponding neighbor cell IDs. The RNC also reports uplink load conditions of the set of neighbor cells to the base station. The UE and the RNC reports to the base station enable improved base station power grant allocation.

The base station scheduler receives relative SNPL level reporting for the set of neighbor cells with the lowest relative SNPL levels and their corresponding neighbor cell indexes from the UE. The base station scheduler also receives the uplink load conditions for the set of neighbor cells from the RNC. Accordingly, the base station scheduler uses this information to allocate a proper power grant for the UE. This proper power grant is then transmitted from the base station to the UE (e.g., over the E-PUCH) in order to adjust the UE's transmission power without adversely affecting neighbor base stations. As a result, this proper power grant achieves high throughput and effectively prevents neighbor cell overload. In one configuration, the set of neighbor cells is the top N closest neighbor cells to the UE that also have the lowest relative SNPL.

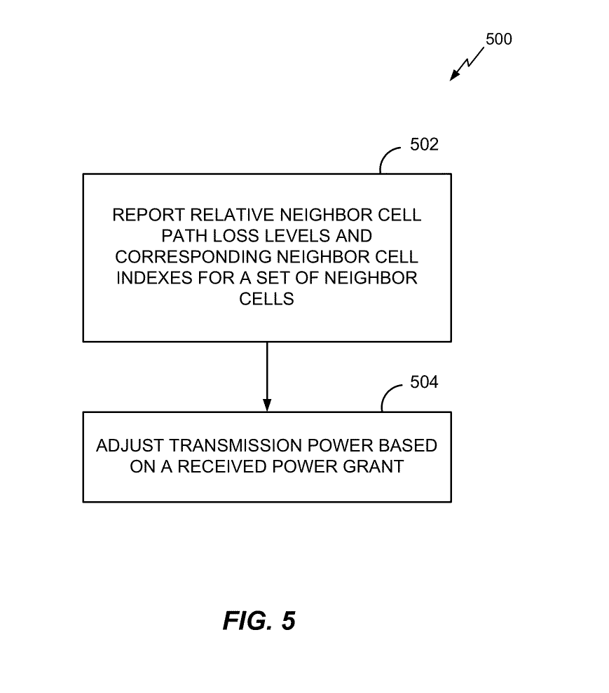

FIG. 5 is a flow diagram illustrating a wireless communication method 500 for reporting relative serving neighbor path loss levels according to aspects of the present disclosure. In block 502, a user equipment (UE) reports, for base station power grant allocation, relative neighbor cell path loss levels and corresponding neighbor cell indexes for a set of intra-frequency neighbor cells. In block 504, the UE adjusts its transmission power based at least in part on a received power grant. The power grant accounts for the report.

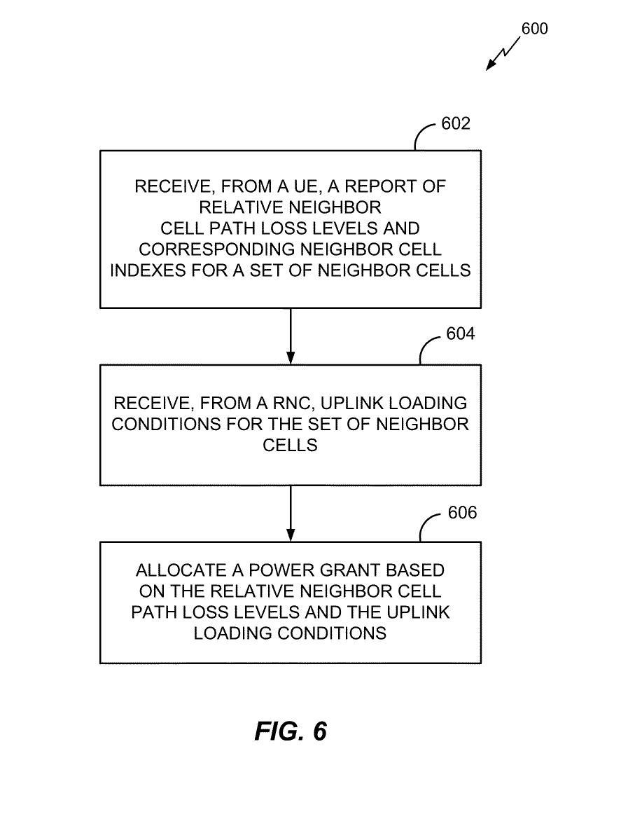

FIG. 6 is a flow diagram illustrating a wireless communication method 600 for receiving relative serving neighbor path loss levels according to aspects of the present disclosure. In block 602, the base station receives, from a UE, a report of relative neighbor cell path loss levels and corresponding neighbor cell indexes for a set of intra-frequency neighbor cells. In block 604, the base station receives, from a radio network controller (RNC), uplink loading conditions for the set of intra-frequency neighbor cells. In block 606, the base station allocates a power grant based on the relative neighbor cell path loss levels and the uplink loading conditions.

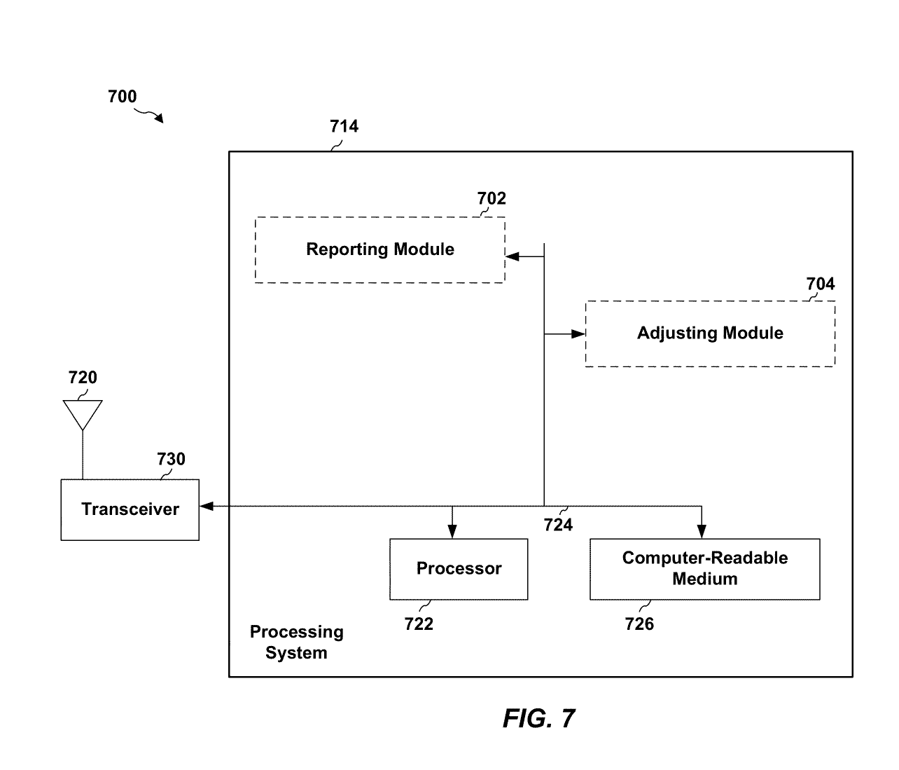

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722, the reporting module 702, the adjusting module 704, and the computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes a reporting module 702 for reporting relative neighbor cell path loss levels and corresponding neighbor cell indexes for a set of intra-frequency neighbor cells. The processing system 714 also includes an adjusting module 704 for adjusting transmission power based on a received power grant. The modules may be software modules running in the processor 722, resident/stored in the computer-readable medium 726, one or more hardware modules coupled to the processor 722, or some combination thereof. The processing system 714 may be a component of the UE 350 and may include the memory 392, and/or the controller/processor 390.

In one configuration, an apparatus such as an UE 350 is configured for wireless communication including means for reporting. In one aspect, the above means may be the antennas 352, the transmitter 356, the transmit processor 380, the controller/processor 390, the memory 392, the relative serving neighbor path loss reporting module 391, the reporting module 702, the processor 722, and/or the processing system 714 configured to perform the functions recited by the aforementioned means. In another aspect, the aforementioned means may be any module or any apparatus configured to perform the functions recited by the aforementioned means.

In one configuration, the apparatus configured for wireless communication also includes means for adjusting. In one aspect, the above means may be the controller/processor 390, the memory 392, the adjusting module 704, the processor 722, and/or the processing system 714 configured to perform the functions recited by the aforementioned means. In another aspect, the aforementioned means may be any module or any apparatus configured to perform the functions recited by the aforementioned means.

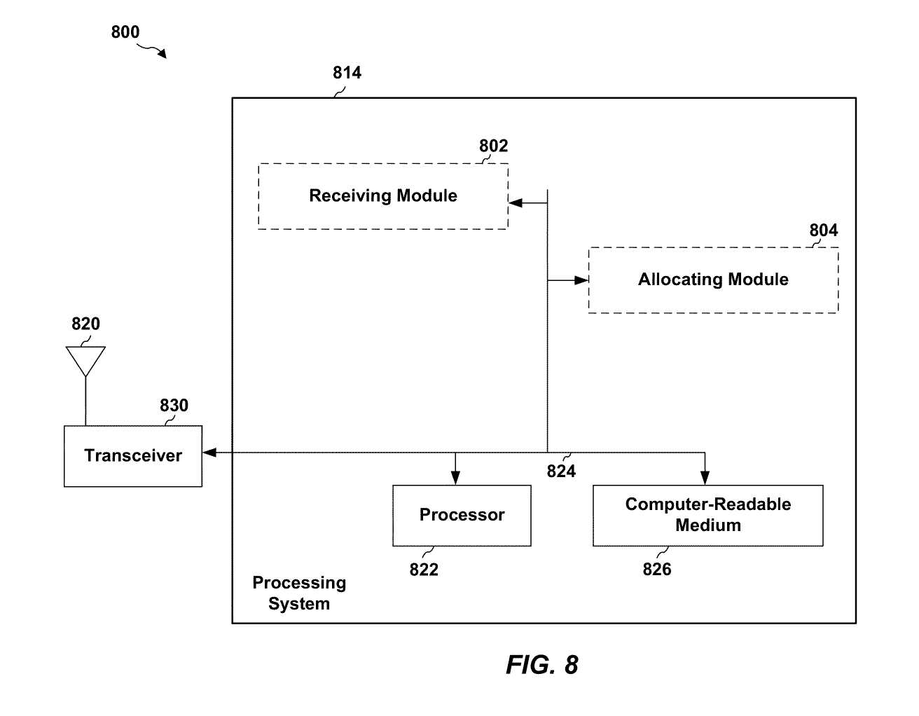

FIG. 8 is a diagram illustrating an example of a hardware implementation for an apparatus 800 employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 822, the receiving module 802, the allocating module 804, and the computer-readable medium 826. The bus 824 may also link various other circuits such as timing sources, peripherals, voltage regulators, and power management circuits, which are well known in the art, and therefore, will not be described any further.

The apparatus includes a processing system 814 coupled to a transceiver 830. The transceiver 830 is coupled to one or more antennas 820. The transceiver 830 enables communicating with various other apparatus over a transmission medium. The processing system 814 includes a processor 822 coupled to a computer-readable medium 826. The processor 822 is responsible for general processing, including the execution of software stored on the computer-readable medium 826. The software, when executed by the processor 822, causes the processing system 814 to perform the various functions described for any particular apparatus. The computer-readable medium 826 may also be used for storing data that is manipulated by the processor 822 when executing software.

The processing system 814 includes a receiving module 802 for receiving a report of relative neighbor cell path loss levels and corresponding neighbor cell indexes for a set of intra-frequency neighbor cells and also receiving uplink loading conditions for the set of intra-frequency neighbor cells. The processing system 814 also includes an allocating module 804 for allocating a power grant based on the relative neighbor cell path loss levels and the uplink loading conditions. The modules may be software modules running in the processor 822, resident/stored in the computer-readable medium 826, one or more hardware modules coupled to the processor 822, or some combination thereof. The processing system 814 may be a component of the node B 310 and may include the memory 342, and/or the controller/processor 340.

In one configuration, an apparatus such as a node B 310 is configured for wireless communication including means for receiving. In one aspect, the above means may be the antennas 334, the receiver 335, the receive processor 338, the controller/processor 340, the memory 342, the relative serving neighbor path loss receiving module 341, the receiving module 802, the processor 822, and/or the processing system 814 configured to perform the functions recited by the aforementioned means. In another aspect, the aforementioned means may be any module or any apparatus configured to perform the functions recited by the aforementioned means.

In one configuration, the apparatus configured for wireless communication also includes means for allocating. In one aspect, the above means may be the antennas 334, the transmitter 332, the transmit processor 320, the controller/processor 340, the memory 342, the allocating module 804, the processor 822, and/or the processing system 814 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA systems and/or TD-HSUPA. As those skilled in the art will readily appreciate, various aspects described throughout this disclosure may be extended to other telecommunication systems, network architectures and communication standards. By way of example, various aspects may be extended to GSM, as well as UMTS systems such as W-CDMA, High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
reporting, for base station power grant allocation, relative neighbor cell path loss levels and corresponding neighbor cell indexes for a plurality of intra-frequency neighbor cells.

2. The method of claim 1, in which the reporting occurs within a schedule request.

3. The method of claim 1, in which each relative neighbor cell path loss level comprises a ratio of neighbor cell path loss to serving cell path loss.

4. The method of claim 1, in which the plurality of intra-frequency neighbor cells comprises neighbor cells with lower path loss levels than other intra-frequency neighbor cells.

5. The method of claim 4, in which the plurality of intra-frequency neighbor cells comprises neighbor cells having absolute path loss below a first threshold and relative path loss below a second threshold.

6. A method of wireless communication, comprising:
receiving, from a user equipment (UE), a report of relative neighbor cell path loss levels and corresponding neighbor cell indexes for a plurality of intra-frequency neighbor cells;
receiving, from a radio network controller (RNC), uplink loading conditions for the plurality of intra-frequency neighbor cells; and
allocating a power grant based at least in part on the relative neighbor cell path loss levels and the uplink loading conditions.

7. The method of claim 6, in which the report of the relative neighbor cell path loss levels and corresponding neighbor cell indexes for the plurality of intra-frequency neighbor cells occurs within a schedule request.

8. The method of claim 6, in which each relative neighbor cell path loss level comprises a ratio of neighbor cell path loss to serving cell path loss.

9. The method of claim 6, in which the plurality of intra-frequency neighbor cells comprises neighbor cells with lower path loss levels than other intra-frequency neighbor cells.

10. The method of claim 9, in which the plurality of intra-frequency neighbor cells comprises neighbor cells having absolute path loss below a first threshold and relative path loss below a second threshold.

11. An apparatus for wireless communication, comprising:
a memory; and
at least one processor coupled to the memory, the at least one processor being configured:
to receive, from a user equipment (UE), a report of relative neighbor cell path loss levels and corresponding neighbor cell indexes for a plurality of intra-frequency neighbor cells;
to receive, from a radio network controller (RNC), uplink loading conditions for the plurality of intra-frequency neighbor cells; and
to allocate a power grant based at least in part on the relative neighbor cell path loss levels and the uplink loading conditions.

12. The apparatus of claim 11, in which the report of the relative neighbor cell path loss levels and corresponding neighbor cell indexes for the plurality of intra-frequency neighbor cells is provided within a schedule request.

13. The apparatus of claim 11, in which each relative neighbor cell path loss level comprises a ratio of neighbor cell path loss to serving cell path loss.

14. The apparatus of claim 11, in which the plurality of intra-frequency neighbor cells comprises neighbor cells with lower path loss levels than other intra-frequency neighbor cells.

15. The apparatus of claim 14, in which the plurality of intra-frequency neighbor cells comprises neighbor cells having absolute path loss below a first threshold and relative path loss below a second threshold.

16. An apparatus for wireless communication, comprising:
a memory; and
at least one processor coupled to the memory, the at least one processor being configured:
to report, for base station power grant allocation, relative neighbor cell path loss levels and corresponding neighbor cell indexes for a plurality of intra-frequency neighbor cells.

17. The apparatus of claim 16, in which the at least one processor is configured to report within a schedule request.

18. The apparatus of claim 16, in which the relative neighbor cell path loss level comprises a ratio of neighbor cell path loss to serving cell path loss.

19. The apparatus of claim 16, in which the plurality of intra-frequency neighbor cells comprises neighbor cells with lower path loss levels than other intra-frequency neighbor cells.

20. The apparatus of claim 19, in which the plurality of intra-frequency neighbor cells comprises neighbor cells having absolute path loss below a first threshold and relative path loss below a second threshold.
